(19) United States
(12) Patent Application Publication
(10) Pub. No.: US 2020/0118481 A1
(43) Pub. Date: Apr. 16, 2020

(54) IMAGING MODULE AND ELECTRONIC DEVICE

(71) Applicant: QISDA CORPORATION, Taoyuan City (TW)

(72) Inventors: Chun-Yi Yen, Taoyuan City (TW); Chin-Chen Kuo, Taoyuan City (TW); Shin-Hao Wu, Taoyuan City (TW)

(21) Appl. No.: 16/260,119

(22) Filed: Jan. 29, 2019

(30) Foreign Application Priority Data
Oct. 16, 2018 (TW) 107136340

(51) Int. Cl. G09G 3/22; G02F 1/1335

(52) U.S. Cl. CPC G09G 3/22; G02F 1/133602; G02F 1/133512

(57) ABSTRACT

An imaging module includes abase, a light source, a light shielding member and a light transmissive member. The light source is disposed in the base. The light shielding member is connected to the base and includes a light transmissive region. The light transmissive member is selectively connected to one of the base and the light shielding member. The light source emits a light towards the light shielding member. The light passes through the light transmissive region and is projected to the light transmissive member, such that the light forms a light pattern corresponding to the light transmissive region through the light transmissive member.

### BACKGROUND OF THE INVENTION

### 1. Field of the Invention

The invention relates to an imaging module and, more particularly, to an imaging module used to form a light pattern and an electronic device equipped with the imaging module.

### 2. Description of the Prior Art

As technology advances and develops, various electronic devices are considered a necessity by a lot of people in their daily lives. When a consumer purchases an electronic device, the appearance is also a major consideration in addition to function. For further illustration, when two electronic devices have identical or similar function, the consumer usually purchases the electronic device with more attractive appearance. Therefore, how to improve the appearance of the electronic device has become a significant design issue.

### SUMMARY OF THE INVENTION

An objective of the invention is to provide an imaging module used to form a light pattern and an electronic device equipped with the imaging module, so as to solve the aforesaid problems.

According to an embodiment of the invention, an imaging module comprises a base, alight source, alight shielding member and a light transmissive member. The light source is disposed in the base. The light shielding member is connected to the base and comprises a light transmissive region. The light transmissive member is selectively connected to one of the base and the light shielding member. The light source emits a light towards the light shielding member. The light passes through the light transmissive region and is projected to the light transmissive member, such that the light forms a light pattern corresponding to the light transmissive region through the light transmissive member.

According to another embodiment of the invention, an electronic device comprises an electronic unit and an imaging module. The imaging module comprises a base, a light source, a light shielding member and a light transmissive member. The electronic unit is disposed on the base. The light source is disposed in the base. The light shielding member is connected to the base and comprises a light transmissive region. The light transmissive member is selectively connected to one of the base and the light shielding member. The light source emits a light towards the light shielding member. The light passes through the light transmissive region and is projected to the light transmissive member, such that the light forms a light pattern corresponding to the light transmissive region through the light transmissive member.

As mentioned in the above, the invention utilizes the light source, the light shielding member and the light transmissive member to cooperate with each other, such that the light emitted by the light source forms the light pattern corresponding to the light transmissive region of the light shielding member through the light transmissive member, so as to improve the appearance of the imaging module and/or the electronic device. Since the structural design is simple, the appearance of the imaging module and/or the electronic device can be improved without increasing much manufacture cost, so as to increase the desire of purchasing the imaging module and/or the electronic device of the invention for a consumer.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a perspective view illustrating an electronic device according to an embodiment of the invention.

FIG. 2 is a perspective view illustrating the imaging module shown in FIG. 1 from another viewing angle.

FIG. 3 is a perspective inner view illustrating the base shown in FIG. 2.

FIG. 4 is a front view illustrating the light source, the light shielding member and the light transmissive member shown in FIG. 3.

FIG. 5 is a schematic view illustrating the light shielding member and the light transmissive member according to another embodiment of the invention.

FIG. 6 is a schematic view illustrating a light shielding member according to another embodiment of the invention.

FIG. 7 is a schematic view illustrating an imaging module according to another embodiment of the invention.

### DETAILED DESCRIPTION

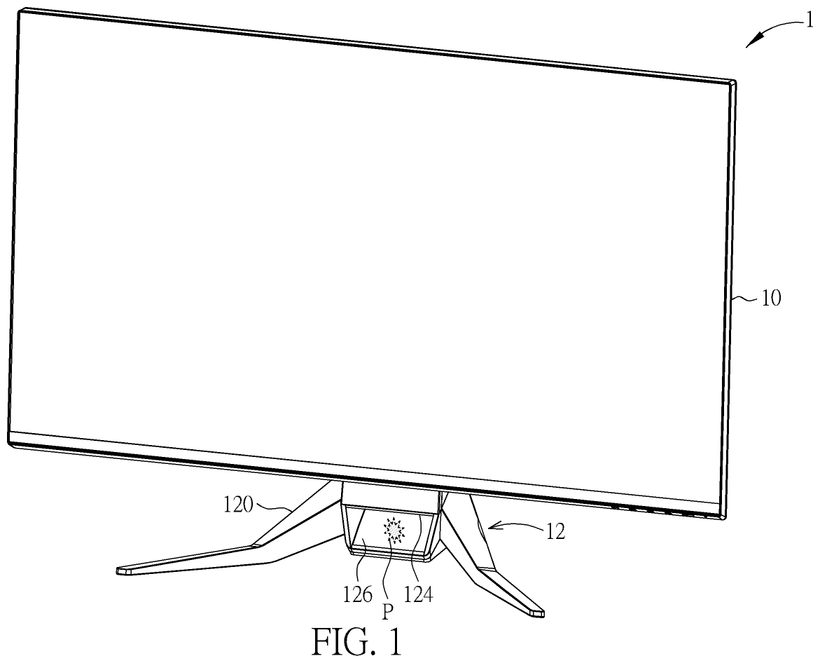

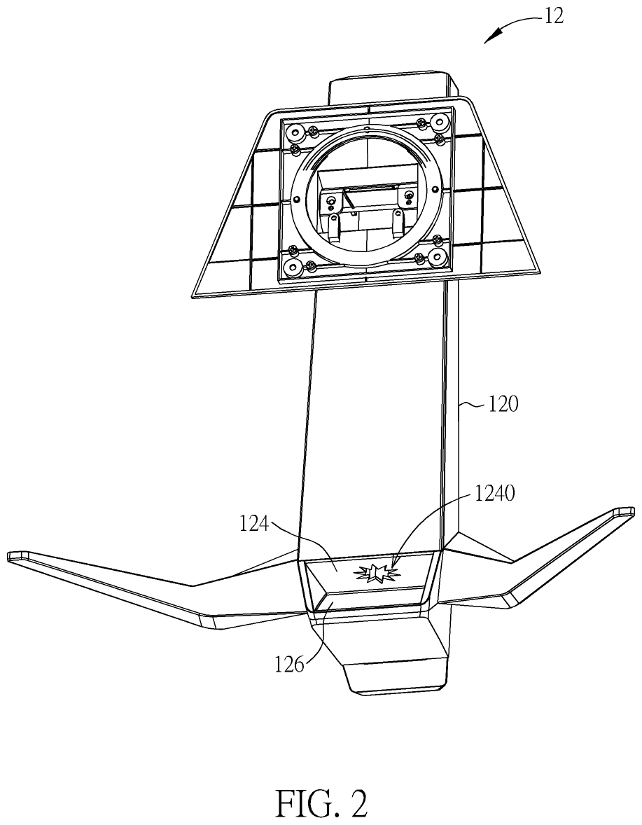

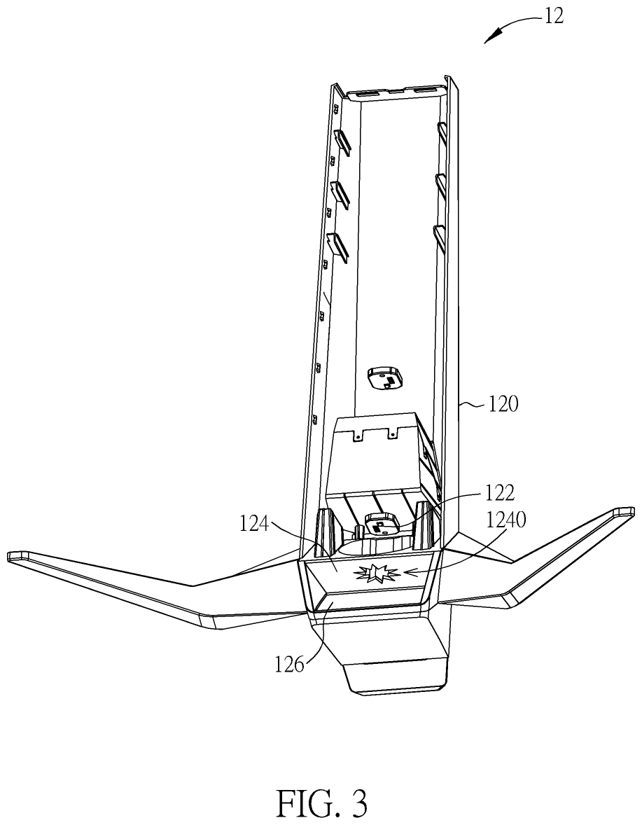

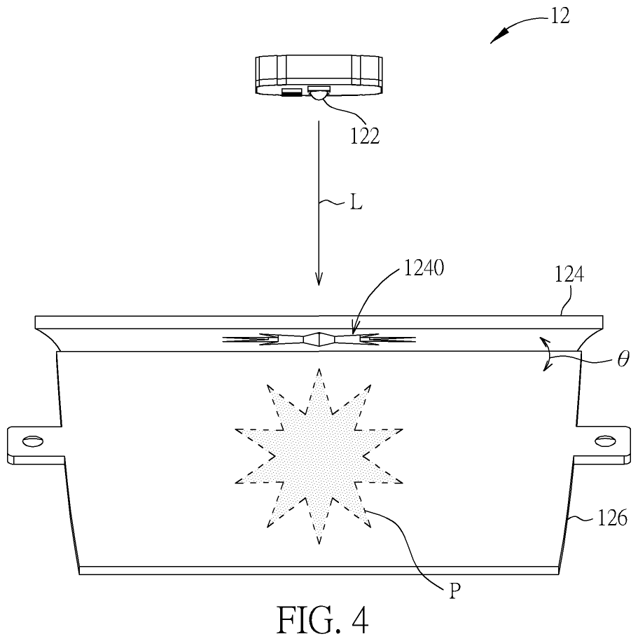

Referring to FIGS. 1 to 4, FIG. 1 is a perspective view illustrating an electronic device 1 according to an embodiment of the invention, FIG. 2 is a perspective view illustrating the imaging module 12 shown in FIG. 1 from another viewing angle, FIG. 3 is a perspective inner view illustrating the base 120 shown in FIG. 2, and FIG. 4 is a front view illustrating the light source 122, the light shielding member 124 and the light transmissive member 126 shown in FIG. 3.

As shown in FIG. 1, the electronic device 1 comprises an electronic unit 10 and an imaging module 12. As shown in FIGS. 2 and 3, the imaging module 12 comprises a base 120, a light source 122, a light shielding member 124 and a light transmissive member 126. The electronic unit 1 is disposed on the base 120 of the imaging module 12. In this embodiment, the electronic unit 10 may be, but not limited to, a display module (e.g. liquid crystal display module, plasma display module, organic light emitting diode display module, etc.) and the base 120 of the imaging module 12 may be, but not limited to, a support base used to support the display module. In another embodiment, the electronic unit 10 may also be replaced by other objects disposed on the base 120 of the imaging module 12. Furthermore, the imaging module 12 may also be used individually instead of cooperating with the electronic unit 10 to form the electronic device 1.

The light source 122 is disposed in the base 120. In this embodiment, the light source 122 may be a light emitting diode or other light emitting components. The light shielding member 124 is connected to the base 120 and comprises a light transmissive region 1240. In this embodiment, the light shielding member 124 may be made of an opaque material (e.g. black plastic) and the light transmissive region 1240 may be a hollow structure formed on the light shielding member 124, wherein the hollow structure may form a predetermined pattern (e.g. the star pattern shown in FIGS. 2 and 3). In other words, the light can only pass through the light transmissive region 1240 of the light shielding member 124 and cannot pass through the light shielding member 124 itself. The light transmissive member 126 is also connected to the base 120. In this embodiment, the light transmissive member 126 may be made of a light transmissive material (e.g. poly(methyl methacrylate) (PMMA), acrylonitrile-butadiene-styrene (ABS), polycarbonate (PC), glass, etc.). In another embodiment of the invention, the light transmissive member 126 may also be connected to the light shielding member 124 instead of the base 120.

In this embodiment, the light shielding member 124 is located between the light source 122 and the light transmissive member 126. As shown in FIG. 4, when the light source 122 emits a light L towards the light shielding member 124, the light L passes through the light transmissive region 1240 of the light shielding member 124 and is projected to the light transmissive member 126, such that the light L forms a light pattern P corresponding to the light transmissive region 1240 of the light shielding member 124 through the light transmissive member 126. In this embodiment, since the light transmissive region 1240 of the light shielding member 124 is a star pattern, the light pattern P formed through the light transmissive member 126 is also a star pattern. Furthermore, since the light transmissive member 126 is made of the light transmissive material, the light transmissive member 126 can refract the light L to form the light pattern P, such that the light pattern P is formed around the light transmissive member 126 (e.g. behind the light transmissive member 126) and has a floating visual effect. For further illustration, since the light pattern P is formed by the light L refracted by the light transmissive member 126, the light pattern P seen by the eyes of a human will float within a range covered by an area of the light transmissive member 126.

In this embodiment, an angle θ included between the light transmissive member 126 and the light shielding member 124 may be between 35 degrees and 45 degrees, such that the light pattern P seen by the eyes of a human may be upright substantially. It should be noted that the angle θ included between the light transmissive member 126 and the light shielding member 124 may also be other angles according to practical applications, such that the light pattern P seen by the eyes of a human may be oblique.

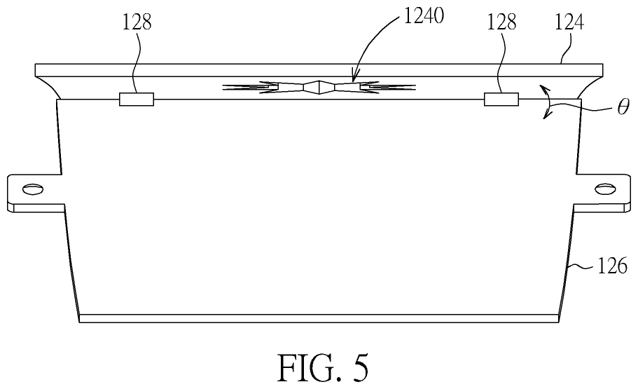

Referring to FIG. 5, FIG. 5 is a schematic view illustrating the light shielding member 124 and the light transmissive member 126 according to another embodiment of the invention. As shown in FIG. 5, the light transmissive member 126 may be pivotally connected to the light shielding member 124 by a hinge 128, such that the angle θ included between the light transmissive member 126 and the light shielding member 124 is adjustable steplessly through the hinge 128. Accordingly, the light transmissive member 126 can be fixed at any angle e with respect to the light shielding member 124, so as to change the state of the light pattern P seen by the eyes of a human. In this embodiment, two hinges 128 maybe symmetrically disposed between the light transmissive member 126 and the light shielding member 124, but is not so limited. It should be noted that the structure and principle of the hinge 128 are well known by one skilled in the art, so those will not be depicted herein in detail.

Therefore, the light transmissive member 126 may be selectively connected to one of the base 120 and the light shielding member 124 according to the aforesaid embodiments.

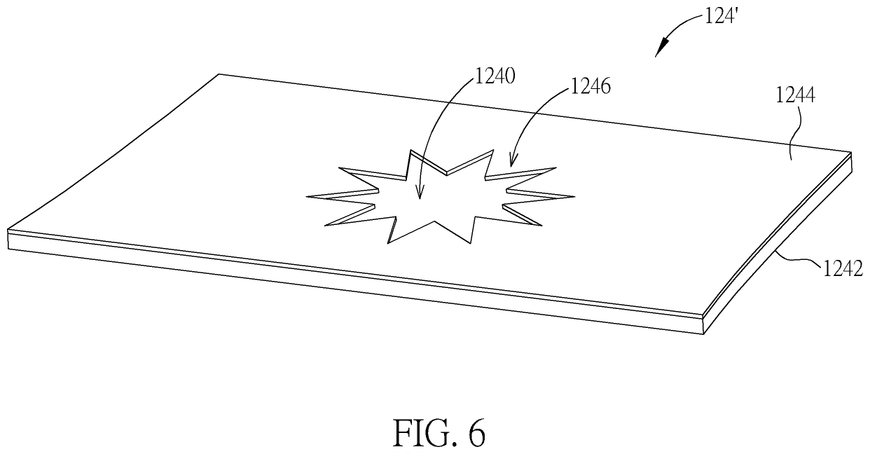

Referring to FIG. 6, FIG. 6 is a schematic view illustrating a light shielding member 124′ according to another embodiment of the invention. The main difference between the light shielding member 124′ and the aforesaid light shielding member 124 is that the light shielding member 124′ comprises a light transmissive sheet 1242 and an opaque layer 1244, as shown in FIG. 6. The opaque layer 1244 is formed on the light transmissive sheet 1242 and the opaque layer 1244 has a hollow structure 1246. A part of the light transmissive sheet 1242 is exposed from the hollow structure 1246 to form the light transmissive region 1240. In this embodiment, the opaque layer 1244 may be black ink or other light absorbing materials, and the opaque layer 1244 may be formed on the light transmissive sheet 1242 by coating or adhesion. Furthermore, the light transmissive sheet 1242 may be made of a light transmissive material (e.g. poly(methyl methacrylate) (PMMA), acrylonitrile-butadiene-styrene (ABS), polycarbonate (PC), glass, etc.). In another embodiment, the light transmissive sheet 1242 may be a filter. Accordingly, when the light passes through the light transmissive region 1240, a wavelength of the light is converted into another wavelength or a wavelength of the light within a specific range can pass through the light transmissive region 1240 only, so as to change the color of the light.

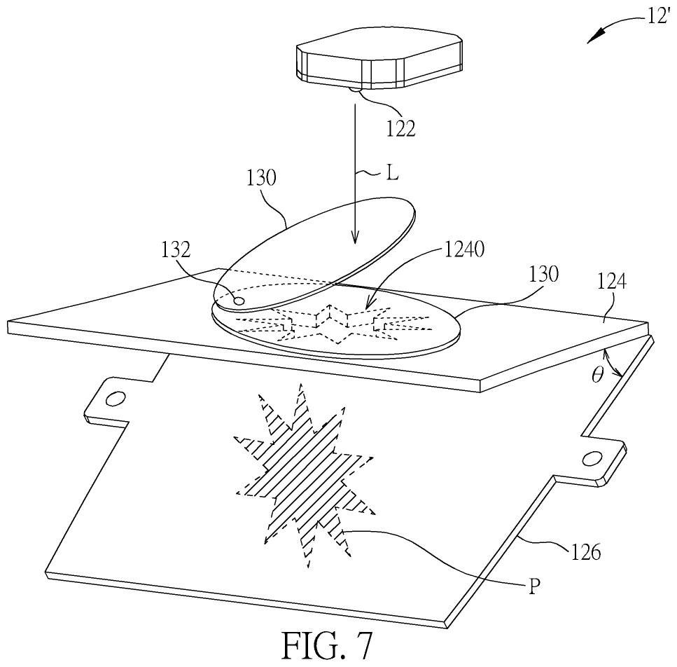

Referring to FIG. 7, FIG. 7 is a schematic view illustrating an imaging module 12′ according to another embodiment of the invention. The main difference between the imaging module 12′ and the aforesaid imaging module 12 is that the imaging module 12′ further comprises at least one filter 130 connected to the light shielding member 124, as shown in FIG. 7. In this embodiment, the imaging module 12′ may comprise two filters 130 and the two filters 130 may be pivotally connected to the light shielding member 124 by a pivot 132. Accordingly, each of the filters 130 is capable of being operated to rotate with respect to the light shielding member 124, so as to cover the light transmissive region 1240 of the light shielding member 124. Therefore, when the light L emitted by the light source 122 passes through the filter 130, a wavelength of the light L is converted into another wavelength or a wavelength of the light L within a specific range can pass through the light transmissive region 1240 only, so as to change the color of the light L. In other words, a user may utilize the filter 130 to change the color of the light L, so as to show different colors for the light pattern P.

In another embodiment, the filter 130 may also be removably disposed on the light shielding member 124 (i.e. the pivot 132 shown in FIG. 7 may be omitted) to cover the light transmissive region 1240 of the light shielding member 124. Accordingly, when the filter 130 is not used, a user can remove the filter 130 from the light shielding member 124.

As mentioned in the above, the invention utilizes the light source, the light shielding member and the light transmissive member to cooperate with each other, such that the light emitted by the light source forms the light pattern corresponding to the light transmissive region of the light shielding member through the light transmissive member, so as to improve the appearance of the imaging module and/or the electronic device. Since the structural design is simple, the appearance of the imaging module and/or the electronic device can be improved without increasing much manufacture cost, so as to increase the desire of purchasing the imaging module and/or the electronic device of the invention for a consumer.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An imaging module comprising:
a base;
a light source disposed in the base;
a light shielding member connected to the base, the light shielding member comprising a light transmissive region;
and
a light transmissive member selectively connected to one of the base and the light shielding member;
wherein the light source emits a light towards the light shielding member, the light passes through the light transmissive region and is projected to the light transmissive member, such that the light forms a light pattern corresponding to the light transmissive region through the light transmissive member.

2. The imaging module of claim 1, wherein the light shielding member is made of an opaque material and the light transmissive region is a hollow structure formed on the light shielding member.

3. The imaging module of claim 1, wherein the light shielding member comprises a light transmissive sheet and an opaque layer, the opaque layer is formed on the light transmissive sheet, the opaque layer has a hollow structure, and a part of the light transmissive sheet is exposed from the hollow structure to form the light transmissive region.

4. The imaging module of claim 3, wherein the light transmissive sheet is a filter.

5. The imaging module of claim 1, wherein the light transmissive member is selectively and pivotally connected to one of the base and the light shielding member.

6. The imaging module of claim 5, wherein the light transmissive member is selectively and pivotally connected to one of the base and the light shielding member by a hinge, such that an angle included between the light transmissive member and the light shielding member is adjustable through the hinge.

7. The imaging module of claim 1, wherein an angle included between the light transmissive member and the light shielding member is between 35 degrees and 45 degrees.

8. The imaging module of claim 1, further comprising at least one filter connected to the light shielding member, the at least one filter being capable of being operated to cover the light transmissive region.

9. The imaging module of claim 1, further comprising at least one filter removably disposed on the light shielding member to cover the light transmissive region.

10. The imaging module of claim 1, wherein the light pattern is formed around the light transmissive member.

11. An electronic device comprising:
an electronic unit; and
an imaging module comprising:
a base, the electronic unit being disposed on the base;
a light source disposed in the base;
a light shielding member connected to the base, the light shielding member comprising a light transmissive region; and
a light transmissive member selectively connected to one of the base and the light shielding member;
wherein the light source emits a light towards the light shielding member, the light passes through the light transmissive region and is projected to the light transmissive member, such that the light forms a light pattern corresponding to the light transmissive region through the light transmissive member.

12. The electronic device of claim 11, wherein the light shielding member is made of an opaque material and the light transmissive region is a hollow structure formed on the light shielding member.

13. The electronic device of claim 11, wherein the light shielding member comprises a light transmissive sheet and an opaque layer, the opaque layer is formed on the light transmissive sheet, the opaque layer has a hollow structure, and a part of the light transmissive sheet is exposed from the hollow structure to form the light transmissive region.

14. The electronic device of claim 13, wherein the light transmissive sheet is a filter.

15. The electronic device of claim 11, wherein the light transmissive member is selectively and pivotally connected to one of the base and the light shielding member.

16. The electronic device of claim 15, wherein the light transmissive member is selectively and pivotally connected to one of the base and the light shielding member by a hinge, such that an angle included between the light transmissive member and the light shielding member is adjustable through the hinge.

17. The electronic device of claim 11, wherein an angle included between the light transmissive member and the light shielding member is between 35 degrees and 45 degrees.

18. The electronic device of claim 11, wherein the imaging module further comprises at least one filter connected to the light shielding member and the at least one filter is capable of being operated to cover the light transmissive region.

19. The electronic device of claim 11, wherein the imaging module further comprises at least one filter removably disposed on the light shielding member to cover the light transmissive region.

20. The electronic device of claim 11, wherein the light pattern is formed around the light transmissive member.

21. The electronic device of claim 11, wherein the electronic unit is a display module.
